(19) United States
(12) Patent Application Publication
(10) Pub. No.: US 2014/0268348 A1
(43) Pub. Date: Sep. 18, 2014

(54) Anti-Reflective Coatings with Porosity Gradient and Methods for Forming the Same

(71) Applicant: INTERMOLECULAR INC., San Jose, CA (US)

(72) Inventors: Scott Jewhurst, Redwood City, CA (US); Nikhil Kalyankar, Mountain View, CA (US)

(73) Assignee: INTERMOLECULAR INC., San Jose, CA (US)

(21) Appl. No.: 13/801,123

(22) Filed: Mar. 13, 2013

(51) Int. Cl. G02B 1/11

(52) U.S. Cl. CPC G02B 1/11
USPC 359/601; 427/164

(57) ABSTRACT

Embodiments provided herein provide anti-reflective coatings with porosity gradients and methods for forming such anti-reflective coatings. A transparent substrate is provided. A primary material and a sacrificial material are simultaneously deposited above the transparent substrate to form a coating above the transparent substrate. At least some of the sacrificial material is removed from the coating to form a plurality of pores in the coating.

The present invention relates to optical coatings. More particularly, this invention relates to anti-reflective coatings with porosity gradients and methods for forming such anti-glare coatings.

### BACKGROUND OF THE INVENTION

Conventional manufacturing of broadband anti-reflective (or anti-reflection) coatings (ARC) for transparent substrates, such as glass or polymers, traditionally requires complicated, multi-step deposition (wet and/or dry) processes of metal oxide or polymer layers. These processing steps require precise control of coating conditions and thickness to provide the correct optical properties in the multi-layer coating. Such coatings also often exhibit less than desirable durability due to failure at one or more of the interfaces (e.g., interlayer or coating-substrate).

Broadband anti-reflective coatings that incorporate a graded porosity to create a refractive index (RI) gradient are particularly demanding to fabricate with wet or dry deposition techniques, as they typically require forming a multilayer coating via layer-by-layer deposition using colloids or oblique angle sputter deposition. The resulting coating, while offering excellent broadband anti-reflection properties, may lack mechanical durability due to low cohesion and poor adhesion to the substrate due to inadequate interparticle and particle-substrate contact area.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 is a cross-sectional view of a substrate with an anti-reflective coating formed thereon, according to some embodiments of the present invention.

FIGS. 2-5 are simplified cross-sectional views of the substrate of FIG. 1 illustrate a method for forming the anti-reflective coating, according to some embodiments of the present invention.

FIG. 6 is a simplified cross-sectional diagram illustrating a physical vapor deposition (PVD) tool, according to some embodiments of the present invention.

FIG. 7 is a flow chart illustrating a method for forming an anti-reflective coating according to some embodiments of the present invention

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Embodiments of the present invention provide optical coatings that improve the anti-reflection performance of transparent substrates. In accordance with one aspect of the invention, this is accomplished by simultaneously depositing two immiscible materials, at least one of which (i.e., a primary material) is transparent, onto a transparent substrate. The other material (i.e., a sacrificial material) is then selectively removed. The resulting coating is porous (i.e., includes pores or voids). The porosity of the coating may be controlled such that the refractive index of the coating has a gradient (e.g., the refractive index gradually changes throughout the coating).

The two materials may be deposited using co-sputtering. The gradient/porosity of the resulting layer may be tuned by independently controlling the rate of deposition of the two materials. For example, in some embodiments, early in the deposition process, the transparent material may be deposited at a higher rate than the sacrificial material, while later in the deposition process, the sacrificial material may be deposited at a higher rate than the transparent material.

Such a deposition process results in the fraction of the transparent material being relatively high in the lower portions of the layer (i.e., near the substrate) and relatively low in the upper portions of the layer (i.e., farther from the substrate). Thus, after the sacrificial material is removed, the porosity of the coating will increase, and the refractive index will decrease, with the porosity decreasing and the refractive index increasing from the interface between the air and the coating (i.e., the air-coating interface) towards the interface between the coating and the substrate (i.e., the coating-substrate interface).

FIG. 1 illustrates a portion of an panel 100, according to some embodiments. The panel 100 includes a transparent substrate 102 and an anti-reflective coating 104 formed on (or above) an upper surface of the transparent substrate 102. In some embodiments, the transparent substrate 102 is made of glass (e.g., annealed or tempered) and has a thickness 106 of, for example, between 0.1 and 2.0 centimeters (cm). In some embodiments, the transparent substrate is made of, for example, ultra-thin glass or polymer. Although only a portion of the panel 100 is shown, it should be understood that the panel 100 (and/or the transparent substrate 102) may, in some embodiments, have a width of, for example, between 5.0 cm and 2.0 meters (m).

In some embodiments, the anti-reflective coating 104 includes (i.e., is made of) a transparent (i.e., primary) material with a refractive index between, for example, 1.29 and 2.40, such as polytetrafluoroethylene (PTFE) or silicon oxide. Still referring to FIG. 1, in some embodiments, the anti-reflective coating 104 has a thickness 108 which ranges between, for example, 100 nanometers (nm) and 3.0 micrometers (μm). As shown, an upper surface 110 of the anti-reflective coating 104 has a series a surface features 112 (i.e., texturing or roughness), which causes the thickness 108 to vary.

The anti-reflective coating 104 also has pores (or voids) 114 formed therein. As shown in FIG. 1, the pores 114 are arranged such that the porosity of the anti-reflective coating 104 increases (and/or the apparent density of the anti-reflective coating 104 decreases) as the anti-reflective coating 104 extends farther from the transparent substrate 102 (i.e., nears the air-coating interface). Likewise, the porosity of the anti-reflective coating 104 decreases (and/or the apparent density of the anti-reflective coating 104 increases) as the anti-reflective coating 104 nears the transparent substrate 102 (i.e., nears the coating-substrate interface). Thus, in general, an upper portion of the anti-reflective coating 104 may have a higher porosity (and/or lower apparent density) than a lower portion of the anti-reflective coating 104 (i.e., located between the transparent substrate 102 and the upper portion of the coating). It should be noted that “porosity” may simply be defined as the fraction (or percentage) of the volume of the anti-reflective coating 104 (or a particular portion of the antireflective coating 104) that is occupied by pores (as opposed to being occupied by the primary material).

In other words, the porosity (and/or apparent density) of the anti-reflective coating 104 is graded (or has a gradient), and as a result, the refractive index of the anti-reflective coating 104 is also graded. In embodiments in which the anti-glare coating 104 is made of PTFE, the refractive index has a maximum refractive index of ˜1.43 near the coating-substrate interface, which gradually decreases to, for example, less than 1.10 near the air-coating interface. In embodiments in which the anti-glare coating 104 is made of silicon oxide, the refractive index has a maximum refractive index of ˜1.50 near the coating-substrate interface, which gradually decreases to, for example, less than 1.10 near the air-coating interface. As will be appreciated by one skilled in the art, the gradient of the refractive index depends on the gradient of the porosity of the refractive index.

FIGS. 2-5 are simplified illustrations depicting a method for forming the anti-reflective coating 104 according to some embodiments. Referring to FIG. 2, a primary (or first) material 200 and a sacrificial (or second) material 202, which is immiscible with the primary material 200, are simultaneously deposited onto the transparent substrate 102. It should be noted that in FIGS. 2-5 particles (or phases) of the primary material 200 and the sacrificial material 202 are shown in a simplified form (e.g., as squares) for sake of clarity.

In some embodiments, the deposition is performed via sputtering (e.g., using physical vapor deposition (PVD)), and the particles of both the primary material 200 and the sacrificial material 202 are between 10 and 100 nm in width, preferably less than 50 nm, in order to allow the formation of a more gradual gradient and to prevent the formation of features large enough to scatter light. The size of the particles in each materials may be controlled by manipulation of the pressure during deposition, sputter power, and distance from target(s) to the substrate 102.

Still referring to FIG. 2, during the initial stages of deposition, the primary material 200 may be deposited at a higher rate than that of the sacrificial material 202 such that the density of the primary material 200 is higher than that of the sacrificial material 202 near the transparent substrate 102. In some embodiments, the deposition process may initially include only deposition of the primary material 200.

As the deposition of the anti-reflective coating continues, the rate of deposition of the primary material 200 is decreased and/or the rate of deposition of the sacrificial material 202 is increased. The result is that the fraction of the primary material 200 decreases, and the fraction of the sacrificial material 202 increases, as the anti-reflective coating 104 extends from the transparent substrate 102. This is depicted in FIG. 3 which shows the anti-reflective coating 104 after the deposition process. In some embodiments, the latter (or final) stages of the deposition process may include mostly deposition of the sacrificial material 202.

Referring to FIGS. 4 and 5, the sacrificial material 202 (or at least some of the sacrificial material 202) is then selectively removed from the anti-reflective coating 104. This process may be performed using, for example, wet or dry etching, solvent extraction, thermal decomposition, pyrolysis, photolysis, or a combination thereof, depending on the materials selected. As the sacrificial material is removed, the pores 114 are formed at the locations of the anti-reflective coating 104 previously occupied by the sacrificial material 202. The result is that the anti-reflective coating 104 has the graded porosity and/density as described above with respect to FIG. 1. It should be noted that in FIGS. 4 and 5, the pores 114 are shown with a cross-hatching solely for illustrative clarity (i.e., to distinguish them from the particles of the primary material 200).

It should be understood that in some embodiments the process used to remove the sacrificial material may not remove all of the particles of the sacrificial material 202. For example, some of the sacrificial material particles 202 near the coating-substrate interface may not be exposed to the removal process and thus remain in the anti-reflective coating 104. The amount of the sacrificial material 202 that remains after the removal process may be, for example, between 0% (i.e., all sacrificial material removed) and 35% of the total amount of sacrificial material 202 deposited during the formation of the anti-reflective coating 104. However, in such instances, the overall porosity (and/or density) profile of the anti-reflective coating 104 may remain substantially intact such that the performance of the anti-reflective coating is not significantly affected.

In some embodiments, the anti-reflective coating 104 is formed using PTFE as the primary material and silicon oxide as the sacrificial material. These two materials may be deposited using co-sputtering via radio-frequency (RF) sputtering or ion-beam sputtering (IBS) (preferably by dual-gun, dual target), with a partial pressure of argon between 1×10⁻³ to 5×10⁻¹ torr in order to generate particles (i.e., discreet phases) with an average size of, for example, between, 2 and 100 nm.

The composite coating (i.e., both the primary and sacrificial materials) may then undergo a low-pressure reactive fluorine etch process (e.g., reactive-ion etching (RIE) or plasma etching), using sulfur hexafluoride (SF₆) or tetrafluoromethane (CF₄) and hydrogen, to etch the silicon oxide phase, forming silicon tetrafluoride (SiF₄), while leaving the PTFE intact. Alternatively, a wet etching process using a hydrofluoric acid solution may be used on the coating (in which case it may be necessary to prevent exposure of the glass substrate to hydrofluoric acid solution). The portions of the coating formerly comprised of silicon oxide then form the graded porosity network that results in a graded refractive index described above.

In some embodiments, the anti-reflective coating 104 is formed using silicon oxide as the primary material and polypropylene (PP) as the sacrificial material. These two materials may be deposited using co-sputtering via RF sputtering or IBS (preferably by dual-gun, dual target), with a partial pressure of argon between 1×10⁻³ to 5×10⁻¹ torr in order to generate particles (i.e., discreet phases) with an average size of, for example, between, 2 and 100 nm.

The composite coating may then undergo a reactive oxygen etch process (plasma etching), or pyrolysis in air above 300° C., to decompose the PP phase, forming volatile carbon dioxide and water, while leaving the silicon oxide intact. The regions of the formerly comprised of PP then form the graded porosity network that results in the graded refractive index described above.

The use of co-sputter deposition of two immiscible materials to form a two phase film, followed by removal of one of the phases, allows the formation of a continuously graded refractive index coating in a single coating operation. Additionally, the use of RF sputtering or IBS (e.g., argon-ion sputtering) allows the controllable co-deposition of a wide range of dielectric materials, including mutually immiscible materials, such as transparent metal oxides and polymers, to form controlled interpenetrating networks of the two discreet phases in a single deposition process. Further, the use of co-deposition to form intermixed, but immiscible phases provides coatings with superior durability compared to those deposited by sol-gel, colloidal, or layer-by-layer deposition, without requiring high-temperature processing, due to the higher interfacial contact area between particles and the particles and the substrate (as may be provided using the co-sputter method described herein due to the smaller possible particle size and conformal particle-particle and particle-substrate interfaces and reactive interfaces).

FIG. 6 provides a simplified illustration of a physical vapor deposition (PVD), or sputter, tool (and/or system) 600 which may be used to form the panel 100 and/or the anti-reflective coating 104 described above, in accordance with some embodiments of the invention. The PVD tool 600 shown in FIG. 6 includes a housing 602 that defines, or encloses, a processing chamber 604, a substrate support 606, a first target assembly 608, and a second target assembly 610.

The housing 602 includes a gas inlet 612 and a gas outlet 614 near a lower region thereof on opposing sides of the substrate support 606. The substrate support 606 is positioned near the lower region of the housing 602 and configured to support a substrate 616. The substrate 616 may be a round glass substrate (or a substrate made of the other materials described above) having a diameter of, for example, about 200 mm or about 300 mm. In other embodiments (such as in a manufacturing environment), the substrate 216 may have other shapes, such as square or rectangular, and may be significantly larger (e.g., about 0.5 m-about 2 m across). The substrate support 606 includes a support electrode 618 and is held at ground potential during processing, as indicated.

The first and second target assemblies (or process heads) 608 and 610 are suspended from an upper region of the housing 602 within the processing chamber 604. The first target assembly 608 includes a first target 620 and a first target electrode 622, and the second target assembly 610 includes a second target 624 and a second target electrode 626. As shown, the first target 620 and the second target 624 are oriented or directed towards the substrate 616. As is commonly understood, the first target 620 and the second target 624 include one or more materials that are to be used to deposit a layer of material 628 on the upper surface of the substrate 616. Although not shown, in some embodiments, the first and second target assemblies 608 and 610 also include one or more magnets.

The materials used in the targets 620 and 624 may include, for example, two immiscible materials such as those described above. Additionally, the materials used in the targets may include oxygen, nitrogen, or a combination of oxygen and nitrogen in order to form oxides, nitrides, and oxynitrides. Further, although only two targets 620 and 624 are shown, additional targets may be used in some embodiments, while in other embodiments, only a single target may be used (e.g., a target made of two suitable immiscible materials). As such, different combinations of targets may be used to form, for example, the anti-reflective coatings described above.

The PVD tool 600 also includes a first power supply 630 coupled to the first target electrode 622 and a second power supply 632 coupled to the second target electrode 624. Although not shown, it should be understood that the first power supply 630 and/or the second power supply 632 may also be coupled to the housing 602 and/or the substrate support 606. During sputtering, an inert gas, such as argon or krypton, may be introduced into the processing chamber 604 through the gas inlet 612, while a vacuum is applied to the gas outlet 614. Ions within the inert gas bombard the targets 620 and 624, causing material to be sputtered (or co-sputtered), or ejected, from the first target 620 and/or the second target 624 (and onto the substrate 616). In the case of RF sputtering, the power supplies 630 and 632 provide power to the first and second targets 620 and 624 while alternating the potential between the targets 620 and 624 and the housing 602 and/or the substrate support 606. In some embodiments, the PVD 600 also includes a ion source/gun (i.e., IBS) to facilitate the deposition process.

Although not shown in FIG. 6, the PVD tool 600 may also include a control system having, for example, a processor and a memory, which is in operable communication with the other components shown in FIG. 6 and configured to control the operation thereof in order to perform the methods described herein. Further, although the PVD tool 600 shown in FIG. 6 includes a stationary substrate support 606, it should be understood that in a manufacturing environment, the substrate 616 may be in motion during the various layers described herein.

FIG. 7 is a flow chart illustrating a method 700 for forming an anti-reflective coating according to some embodiments of the present invention. The method 700 begins at block 702 by providing a transparent substrate such as the examples described above (e.g., glass).

At block 704, the primary material and the sacrificial material are simultaneously deposited onto the transparent substrate. The deposition of the primary and sacrificial materials may be performed according to the details provided above using, for example, the PVD tool 600 shown in FIG. 6. The combination of the primary material and the sacrificial material may be understood to form a composite anti-reflective coating on the transparent substrate.

Referring again to FIG. 7, at block 706, the sacrificial material (or at least some of the sacrificial material) is removed. As described above, the removal of the sacrificial material may be performed using, for example, wet or dry etching, solvent extraction, thermal decomposition, pyrolysis, photolysis, or a combination thereof. The removal of the sacrificial material causes the sacrificial material (or at least some of the sacrificial material) within the composite anti-reflective coating is replaced with pores.

At block 708, the method 700 ends with the anti-reflective coating having been formed on the transparent substrate. In some embodiments, no additional processing may be required.

Thus, in some embodiments, a method for forming an anti-reflective coating is provided. A transparent substrate is provided. A primary material and a sacrificial material are simultaneously deposited onto the transparent substrate to form a coating above the transparent substrate. The sacrificial material is removed from the coating to form a plurality of pores in the coating.

In some embodiments, a method for forming an anti-reflective coating is provided. A transparent substrate is provided. A primary material and a sacrificial material are simultaneously deposited onto the transparent substrate to form a coating above the transparent substrate. The primary material and the sacrificial material are immiscible. The sacrificial material is removed from the coating to form a plurality of pores in the layer. The plurality of pores are arranged such that the coating has a graded refractive index that decreases as the coating extends away from the transparent substrate

In some embodiments, a panel is provided. The panel includes a transparent substrate and an anti-reflective coating formed above the transparent substrate. The anti-reflective coating includes a transparent material having a refractive index between 1.29 and 2.40 and an average particle size between 2 nm and 100 nm and a plurality of pores formed therein. The plurality of pores are arranged such that a density of the anti-reflective coating decreases as the anti-reflective coating extends away from the transparent substrate.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method for forming an anti-reflective coating comprising:
providing a transparent substrate;
simultaneously depositing a primary material and a sacrificial material onto the transparent substrate to form a coating above the transparent substrate; and
removing the sacrificial material from the coating to form a plurality of pores in the coating.

2. The method of claim 1, wherein the primary material is transparent.

3. The method of claim 2, wherein during the simultaneous deposition of the primary material and the sacrificial material, the rate of deposition of the primary material is decreased.

4. The method of claim 3, wherein during the simultaneous deposition of the primary material and the sacrificial material, the rate of deposition of the sacrificial material is increased.

5. The method of claim 1, wherein after the removing of the sacrificial material from the coating, a first portion of the layer has a first porosity and a second portion of the layer has a second porosity.

6. The method of claim 5, wherein the second portion of the coating is between the transparent substrate and the first portion of the coating, and the first porosity is greater than the second porosity.

7. The method of claim 1, wherein the primary material has a refractive index between 1.29 and 2.40.

8. The method of claim 1, wherein the primary material and the sacrificial material are immiscible.

9. The method of claim 1, wherein the removing of the sacrificial material from the coating comprises wet etching, dry etching, solvent extraction, thermal decomposition, pyrolysis, photolysis, or a combination thereof.

10. The method of claim 1, wherein after the removing of the sacrificial material from the coating, the coating has a graded refractive index that decreases as the coating extends away from the transparent substrate.

11. A method for forming an anti-reflective coating comprising:
providing a transparent substrate;
simultaneously depositing a primary material and a sacrificial material onto the transparent substrate to form a coating above the transparent substrate, wherein the primary material and the sacrificial material are immiscible; and
removing the sacrificial material from the coating to form a plurality of pores in the layer, wherein the plurality of pores are arranged such that the coating has a graded refractive index that decreases as the coating extends away from the transparent substrate.

12. The method of claim 1, wherein during the simultaneous deposition of the primary material and the sacrificial material, the rate of deposition of the primary material is decreased and the rate of deposition of the sacrificial material is increased.

13. The method of claim 12, wherein the primary material has a refractive index between 1.29 and 2.40.

14. The method of claim 13, wherein the removing of the sacrificial material from the coating comprises wet etching, dry etching, solvent extraction, thermal decomposition, pyrolysis, photolysis, or a combination thereof.

15. The method of claim 14, wherein during the simultaneous deposition of the primary material and the sacrificial material, the primary material and the sacrificial material each have an average particle size between 2 nm and 100 nm.

16. An panel comprising:
a transparent substrate; and
an anti-reflective coating formed above the transparent substrate, the anti-reflective coating comprising a transparent material having an refractive index between 1.29 and 2.40 and an average particle size between 2 nm and 100 nm and a plurality of pores formed therein, wherein the plurality of pores are arranged such that a density of the anti-reflective coating decreases as the anti-reflective coating extends away from the transparent substrate.

17. The panel of claim 16, wherein the anti-reflective coating has a thickness between 100 nm and 3 μm.

18. The panel of claim 17, wherein the transparent substrate comprises glass, polymer, fabric, silicon, plastic, metal, or a combination thereof.

19. The panel of claim 18, wherein the transparent material comprises as polytetrafluoroethylene (PTFE).

20. The panel of claim 18, wherein the transparent material comprises silicon oxide.
